(19) United States
(12) Patent Application Publication
(10) Pub. No.: US 2019/0366938 A1
(43) Pub. Date: Dec. 5, 2019

(54) SADDLE MOUNT TO SUPPORT A FISHING KAYAK

(71) Applicant: Yakima Products, Inc., Lake Oswego, OR (US)

(72) Inventors: Charles Kraeuter, Portland, OR (US); Warren E. Stoneburner, Scottsdale, AZ (US)

(73) Assignee: Yakima Products, Inc., Lake Oswego, OR (US)

(21) Appl. No.: 16/432,773

(22) Filed: Jun. 5, 2019

Related U.S. Application Data
(60) Provisional application No. 62/681,002, filed on Jun. 5, 2018.

(51) Int. Cl. B60R 9/08; B60R 9/048

(52) U.S. Cl. CPC B60R 9/08; B60R 9/048

(57) ABSTRACT

Saddle mounts for supporting a boat, such as a fishing kayak, above a crossbar attached to a vehicle, a vehicle rack including the saddle mounts, and methods of assembling a vehicle rack including the saddle mounts. An illustrative saddle mount may comprise an encircling member configured to be attached to a crossbar. The encircling member may have a horizontal bottom section and a top section. The top section may include a medial portion and a lateral portion. The medial portion may have an incline of less than about ten degrees, and the lateral portion may have an incline steeper than the incline of the medial portion. Another illustrative saddle mount may comprise an encircling member including a rib, such as a recessed rib, for providing load strength. The rib may be elongated along an encircling path followed by the encircling member.

### CROSS-REFERENCE TO PRIORITY APPLICATION

This application is based upon and claims the benefit under 35 U.S.C. § 119(e) of U.S. Provisional Patent Application Ser. No. 62/681,002, filed Jun. 5, 2018, which is incorporated herein by reference in its entirety for all purposes.

### FIELD

The field of the disclosure is vehicle racks, in particular, saddle mounts for carrying a boat on a vehicle rack.

### INTRODUCTION

Boats such as kayaks and canoes are commonly carried on vehicles. For example, saddle mounts secured to crossbars on top of a vehicle are often used to carry relatively small boats. Recently, fishing kayaks have become a popular accessory for fishermen. Compared to a regular kayak, a fishing kayak typically has a larger, more flattened bottom shape and is significantly heavier. Existing saddle mounts are unsatisfactory for carrying fishing kayaks.

### SUMMARY

The present disclosure provides saddle mounts for supporting a boat, such as a fishing kayak, above a crossbar attached to a vehicle, a vehicle rack including the saddle mounts, and methods of assembling a vehicle rack including the saddle mounts. An illustrative saddle mount may comprise an encircling member configured to be attached to a crossbar. The encircling member may have a horizontal bottom section and a top section. The top section may include a medial portion and a lateral portion. The medial portion may have an incline of less than about ten degrees, and the lateral portion may have an incline steeper than the incline of the medial portion. Another illustrative saddle mount may comprise an encircling member including a rib, such as a recessed rib, for providing load strength. The rib may be elongated along an encircling path followed by the encircling member.

### BRIEF DESCRIPTION OF THE DRAWINGS

FIG. 1 is an isometric view of a vehicle rack system including a fishing kayak supported above a vehicle by front and rear cradles, with each cradle including a pair of saddle mounts attached to a crossbar of a vehicle rack, and with the fishing kayak and vehicle shown in phantom, in accordance with aspects of the present disclosure.

FIG. 2 is a fragmentary, sectional view of the vehicle rack system of FIG. 1, taken generally along line 2-2 of FIG. 1 through the fishing kayak toward one of the crossbars and cradles and illustrating how the saddle mounts support the fishing kayak.

FIG. 3 is an oblique view of one of the saddle mounts of FIG. 2.

FIG. 4 is another oblique view of the saddle mount of FIG. 2 showing the opposite side of the saddle mount relative to FIG. 3.

FIG. 5 is a medial end view of the saddle mount of FIG. 2.

FIG. 6 is a lateral end view of the saddle mount of FIG. 2.

FIG. 7 is a side view of only the encircling member of the saddle mount of FIG. 2, taken at elevation.

FIG. 8 is a sectional view of the encircling member of FIG. 7, taken generally along line 8-8 of FIG. 7.

FIG. 9 is an exploded, partially sectional view of the saddle mount of FIG. 2, taken generally along line 9-9 of FIG. 8 through the encircling member of the saddle mount.

FIG. 10 is a top view of only the encircling member of the saddle mount of FIG. 2.

FIG. 11 is a bottom view of only the encircling member of the saddle mount of FIG. 2.

FIG. 12 is a sectional view of the encircling member of the saddle mount of FIG. 2 attached to a slot of a crossbar, taken generally along line 12-12 of FIG. 8 through the encircling member and the crossbar, with the crossbar-coupling assembly of the saddle mount of FIG. 2 replaced by a slot-coupling assembly.

FIG. 13 is an isometric view of a slidable member of the slot-coupling assembly of FIG. 12.

FIG. 14 an exploded view of the saddle mount of FIG. 2, taken with the crossbar-clamping assembly of FIG. 2 replaced by a different crossbar-clamping assembly configured for round crossbars, although the crossbar-clamping assemblies of FIGS. 2 and 14 may be used together in the same saddle mount.

FIG. 15 is a view of a clamp member of the crossbar-clamping assembly of FIG. 14.

### DETAILED DESCRIPTION

The present disclosure provides saddle mounts for supporting a boat, such as a fishing kayak, above a crossbar attached to a vehicle, a vehicle rack including the saddle mounts, and methods of assembling a vehicle rack including the saddle mounts. Although the saddle mounts are described in the context of supporting a fishing kayak, they offer a relatively universal solution for supporting boats of various sizes and shapes.

An illustrative saddle mount may comprise an encircling member configured to be attached to a crossbar. The encircling member may have a horizontal bottom section and a top section, where the top section is configured to be connected to the crossbar via the bottom section. The top section may include a medial portion and a lateral portion. The medial portion may have an incline of less than about ten or twenty degrees, and the lateral portion may have an incline steeper than the incline of the medial portion. One or both inclines may have a substantially constant slope. The medial portion may be configured to support more of the load than the lateral portion, and thus may be wider and/or longer than the lateral portion.

Another illustrative saddle mount may comprise an encircling member including a rib, such as a recessed rib, for providing load strength. The rib may be elongated along an encircling path followed by the encircling member. The rib allows the saddle mount to support heavier loads, without excessive deformation of the encircling member, and, in some examples, without substantially increasing the saddle mount's weight.

Yet another illustrative saddle mount may comprise an encircling member following an encircling path defining a plane. The encircling member may be configured to be attached to the crossbar such that the plane is parallel to the crossbar. The encircling member may include a lower section, an upper section, and pair of end sections opposite one another. Each end section may extend along a curved portion of the encircling path from the lower section to the upper section. The end sections may function as medial and lateral springs that suspend the upper section (and the fishing kayak or other boat) above the lower section. The springs may be tuned to absorb shocks and reduce vibration. The medial spring and an adjacent medial portion of the upper section may support more of the load and thus may be wider than the lateral spring and an adjacent lateral portion of the upper section.

Fishing kayaks are new gear in the fishing world and are gaining a lot of momentum. They are typically heavier than a normal kayak and have a unique hull/keel shape due to their use. The present disclosure provides novel saddle mount configurations characterized by customized shapes for cradling the hull of a fishing kayak, and keeping associated equipment safe. A pair of cradles formed by a set of four saddle mounts, as disclosed herein, may be strong enough to carry at least about 100, 125, or 150 pounds (i.e., a fishing kayak and associated gear/equipment), while still offering some compliance to optimally nestle the hull of the fishing kayak. Accordingly, the pair of cradles may provide the highest load rating on the market currently, namely, at least about 150 pounds.

An exemplary saddle mount may have frictional pads (e.g., elastomeric pads) to keep a fishing kayak from shifting during transport. Each frictional pad may be attached to an encircling body of the encircling member. The frictional pad may protrude above an upper region of the outer surface of the encircling body, for preferential contact with the fishing kayak. The saddle mount also may have optional low-friction pads that can be placed on each saddle mount of a pair of saddle mounts that form a cradle (e.g., a rear cradle) above a crossbar. The low-friction pads facilitate sliding the fishing kayak onto the cradles during loading by providing a lower friction, more slippery surface adjacent each frictional pad. Each low-friction pad may have a top surface that is substantially flush or slightly elevated with respect to the adjacent frictional pad. The low-friction pad may be formed of a compressible material, such as felt, so that the frictional pad still can engage the fishing kayak, after it is loaded, to limit shifting during transport.

The present disclosure describes different, interchangeable mounting options for attaching a saddle mount to a crossbar. The mounting options utilize two or more different crossbar-coupling assemblies that can be removably, interchangeably, and/or additively connected to an encircling member of the saddle mount. Each crossbar-coupling assembly may be described as a clamp device. The crossbar-coupling assemblies may include any combination of a first clamp device for a substantially universal crossbar fit, a second clamp device for round/rectangular crossbars, and/or a third clamp device that attaches the encircling member to a T slot of a crossbar. The third clamp device for slotted crossbars offers the lowest profile mounting solution. For each of these clamp devices, the encircling member may provide one or more jaw members to engage an upper surface region of a crossbar, while the clamp device engages at least an underside or a slot of the crossbar and adjustably urges the crossbar upward against the jaw member(s) of the encircling member.

The first clamp device (for universal crossbar fit) may utilize a bail assembly including a bail that engages an underside of the crossbar, and a bail mount that removably and pivotably connects the bail to the encircling member. The bail mount may be reversibly connected to the encircling member, which gives the user a choice of left or right (forward/aft) access. Alternatively, the bail mount and bail may be removed completely before attaching the encircling member to a crossbar slot. The first and second clamp devices may be used together, to grip a round crossbar more effectively, to prevent the saddle mount from rotating about the crossbar.

Further exemplary, non-limiting aspects of the saddle mount are described in the following sections: (I) vehicle rack system with illustrative saddle mounts, (II) selected examples, and (III) conclusion. The term “exemplary” as used in the present disclosure, means illustrative or serving as an example. Similarly, the term “exemplify” means to illustrate by giving an example. Neither term implies desirability nor superiority.

### I. Vehicle Rack System with Illustrative Saddle Mounts

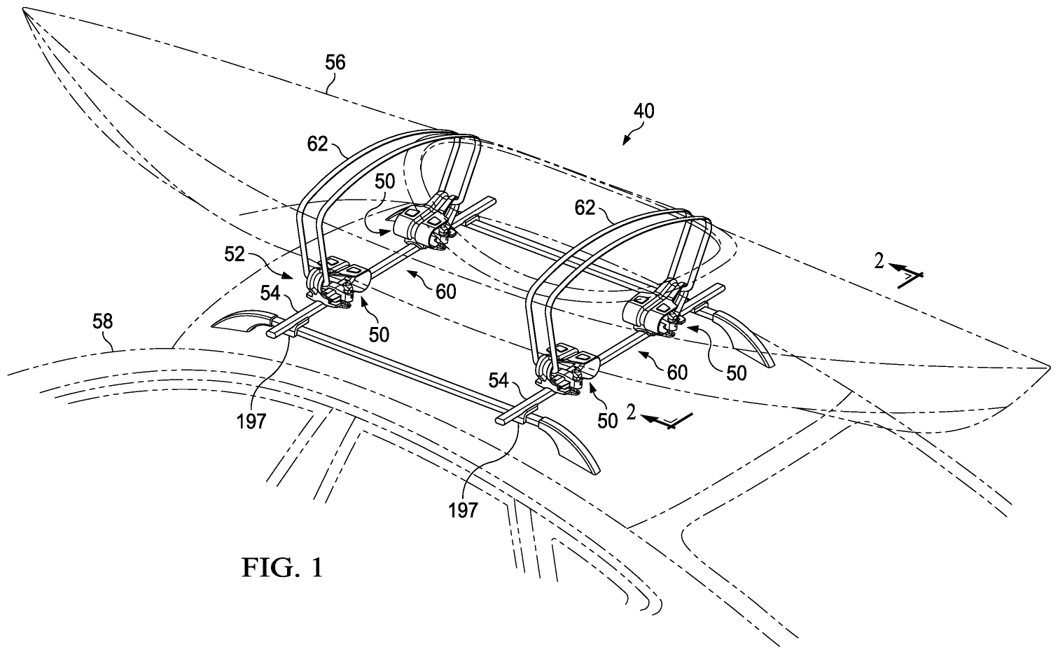

This section describes a vehicle rack system 40 including illustrative saddle mounts 50 for a vehicle rack 52 including a pair of crossbars 54; see FIGS. 1-15.

FIG. 1 shows a fishing kayak 56 supported above a vehicle 58 by a pair of cradles 60. Each cradle 60 includes a pair of saddle mounts 50 mounted to the same front or rear crossbar 54. One or more straps 62 may extend through saddle mounts 50 and over fishing kayak 56 to secure the fishing kayak to each cradle 60. Saddle mounts 50 can be utilized to support any suitable kayak or other boat, but may be especially configured to support a fishing kayak, which is typically heavier than other kayaks and characterized by a unique hull shape.

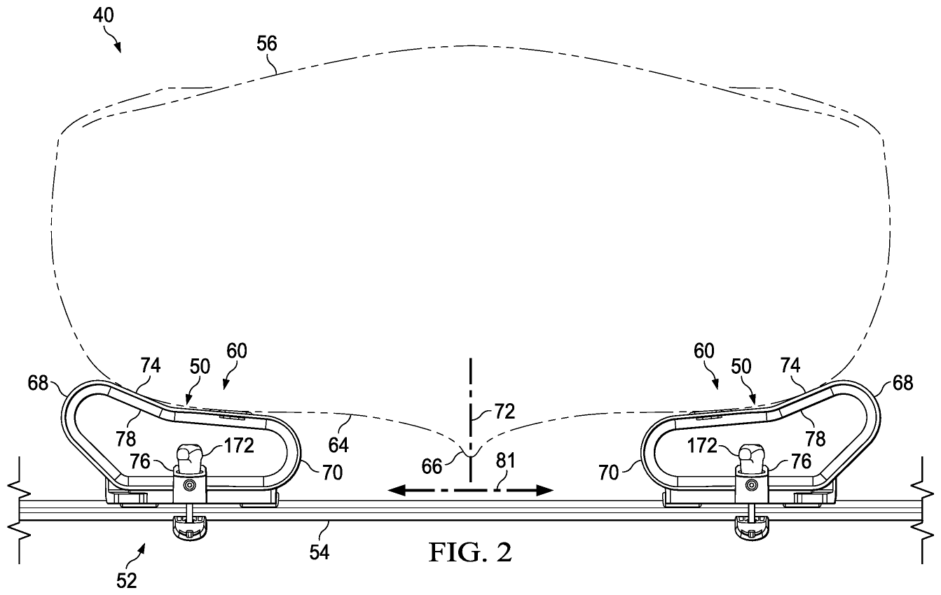

FIG. 2 shows one of cradles 60 supporting fishing kayak 56. Cradle 60 may be formed by a pair of saddle mounts 50 that are substantially identical to one another, but mounted to crossbar 54 with a 180-degree rotational offset, as shown. Saddle mounts 50 may be mounted in a spaced relationship to one another along crossbar 54, generally according to the width of the hull 64 of fishing kayak 56. Keel 66 of fishing kayak 56 is centered between saddle mounts 50.

Each saddle mount 50 has a lateral end 68 opposite a medial end 70. The terms “lateral” and “medial” are used herein to indicate relative proximity to a central plane 72 centered between saddle mounts 50 of each cradle 60, with “medial” being closer than “lateral” to central plane 72.

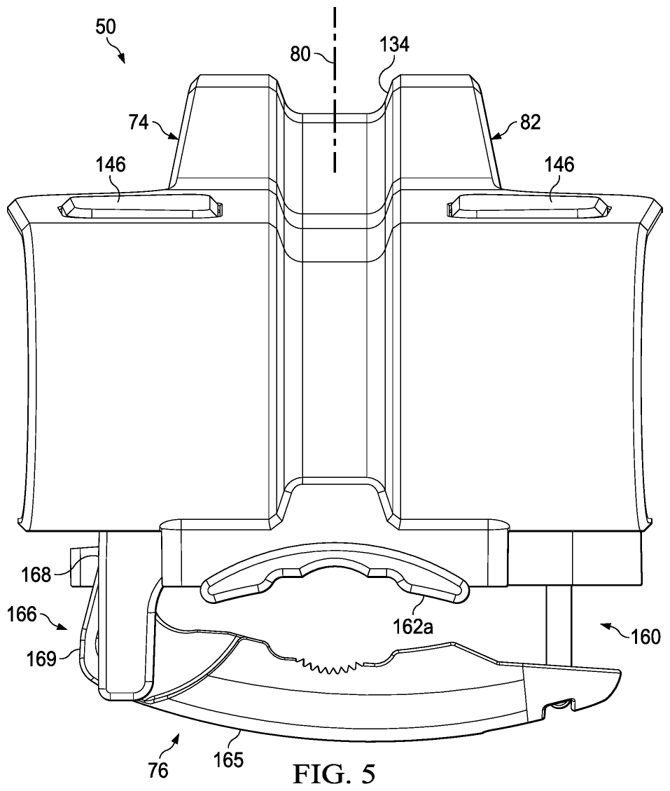

Saddle mount 50 includes an encircling member 74 mounted to crossbar 54 via a crossbar-coupling assembly 76 (see FIGS. 2-4). Encircling member 74 supports fishing kayak 56 above a central opening 78. Central opening 78 may be substantially empty during use of the saddle mount 50. The encircling member encircles central opening 78 in a plane 80 and defines central opening 78 (see FIGS. 5, 7, and 10). Plane 80 may be parallel to crossbar 54, and, more specifically, parallel to a long axis 81 defined by crossbar 54 (see FIG. 2). Central opening 78 has a length (measured along a line extending between lateral and medial ends 68, 70) and a height (measured vertically). The length and height, respectively, of central opening 78 may be more than at least one-half of the length and height of encircling member 74 measured the same way, such as at least 75% of the length and/or height, among others.

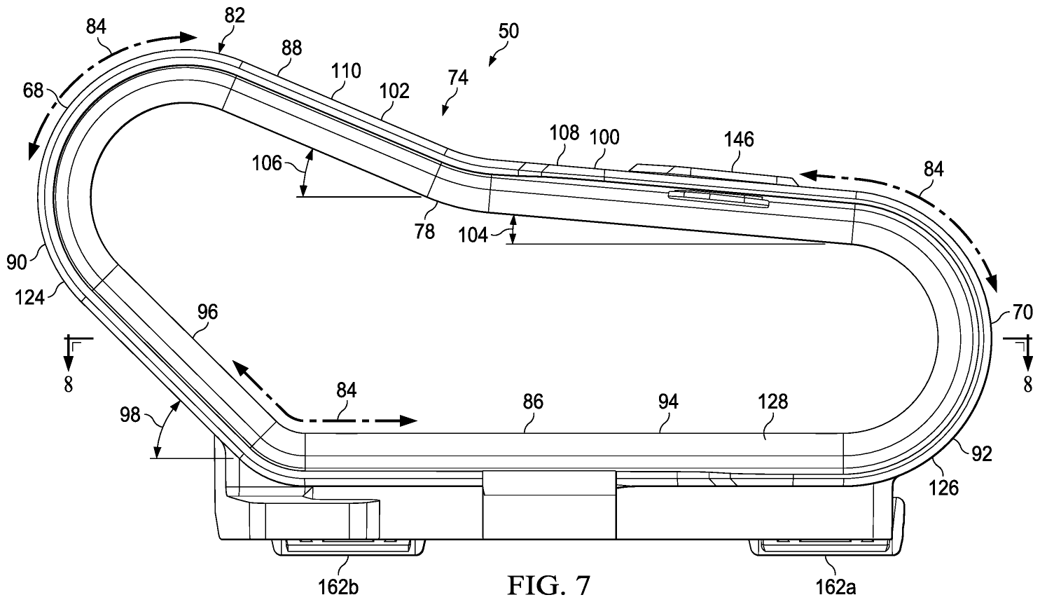

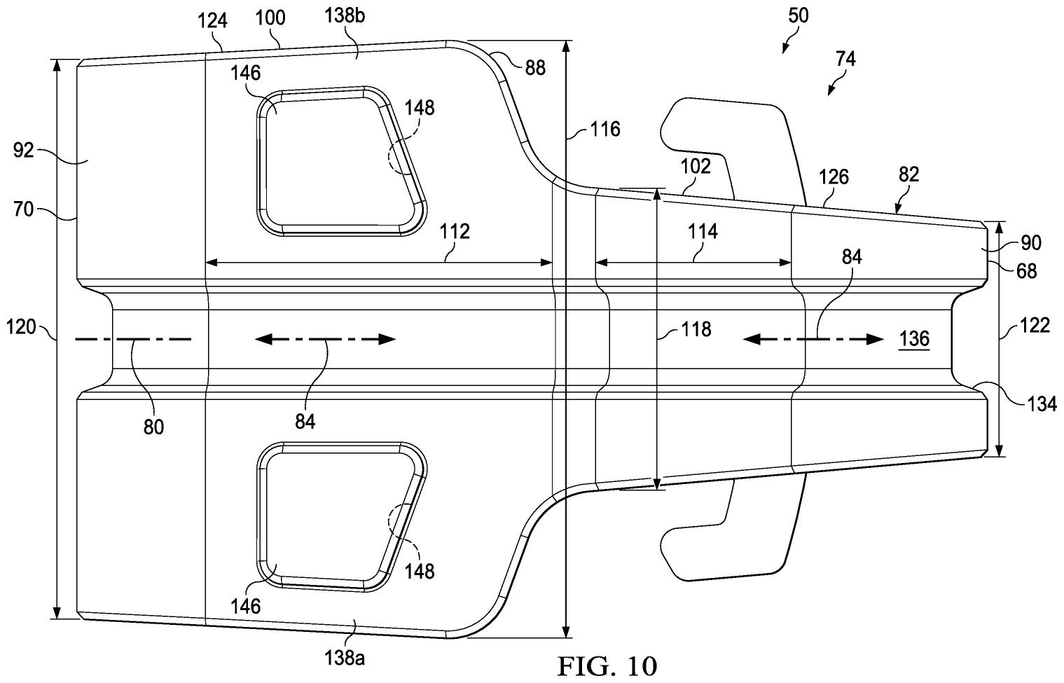

Encircling member 74 includes an encircling body 82 that extends along an encircling path 84 in a complete loop around central opening 78 (see FIG. 7). Encircling path 84 may define plane 80 (also see FIGS. 5 and 10). Encircling body 82 may be unitary (i.e., no removable parts) and/or formed integrally (as a single piece). Encircling member 74 and/or encircling body 82 is preferably composed of a polymeric material, such as unfilled nylon for the encircling body. In some examples, encircling member 74 and/or encircling body 82 has an average thickness of less than about 10, 8, 7, 6, or 5 millimeters, among others.

Encircling body 82 (and/or encircling member 74) has a lower section 86 and an upper section 88 (see FIG. 7). Lower and upper sections 86, 88 are connected to one another at lateral and medial ends thereof by a lateral end section 90 and a medial end section 92, respectively. Lateral and medial end sections 90, 92 may be curved along encircling path 84 in a plane parallel to plane 80 (also see FIG. 5). Either or both end sections 90, 92 may smoothly curve through a change in orientation of at least about 120, 130, 140, or 150 degrees in the plane. Curved end sections 90, 92 complement the linear sections/portions described below.

Lower section 86 may include a bottom section 94 and an inclined section 96. Bottom section 94 may be substantially horizontal. Inclined section 96 is located on encircling path 84 between lateral end section 90 and bottom section 94. The inclined section may have any suitable slope with respect to horizontal, such as being inclined at an angle 98 of about 20-70, 30-60, 35-55, or 40-50 degrees, among others. Each of bottom section 94 and inclined section 96 may be substantially linear in profile (e.g., as viewed in FIG. 7), and lower section 86 may be composed predominantly of sections/portions that are linear in profile.

Upper section 88 may have a pair of inclined portions, namely, a medial portion 100 and a lateral portion 102. Medial portion 100 may be only slightly inclined, at a medial angle 104, and lateral portion 102 may be more steeply inclined than medial portion 100, at a lateral angle 106. Medial angle 104 may be less than about 20 or 10 degrees, and may be about 1-10, 2-8, 3-7, or 4-6 degrees, or about 5 degrees, among others. Lateral angle 106 may be less than about 45, 40, 35, or 30 degrees, among others, and may be about 15-30 or 20-25 degrees, or about 23 degrees, among others. Either or both of medial and lateral portions 100, 102 may be substantially linear in probe, with a substantially constant slope. Medial and lateral portions 100, 102 may provide respective upper surfaces 108, 110 on which to support fishing kayak 56. Each of surfaces 108, 110 may be substantially planar.

Medial portion 100 may provide a substantially larger load-supporting area than lateral portion 102, to support more of the load (see FIG. 10). The medial portion has a medial length 112 and the lateral portion has a lateral length 114 measured along encircling path 84. Medial length 112 may be substantially greater than lateral length 114, such as at least about 50%, 60% or 70% greater, among others. Medial portion 100 has a maximum (or average) medial width 116, and lateral portion 102 has a maximum (or average) lateral width 118, measured perpendicular to plane 80. Medial width 116 may be substantially greater than lateral width 118, such as at least about 50%, 75%, or 100% greater.

Encircling member 74 may be wider medially than laterally, consistent with the need for greater strength medially than laterally. Medial end section 92 has a medial width 120, and lateral end section 90 (and/or inclined section 96) has a lateral width 122, each of which may be an average or maximum width. Medial width 120 may be substantially greater than lateral width 122, such as at least about 50% or 75% greater, or at least about twice lateral width 122. Moreover, encircling member 74 may have a medial region 124 (medial end section 92 and medial portion 100) and a lateral region 126 (lateral end section 92, inclined section 96, and, optionally, bottom section 94) (also see FIG. 7). Medial region 124 may be substantially wider than lateral region 126 (orthogonal to plane 80), such as having an average width that is at least about 50%, 70%, or 80% greater, or at least about twice the width of the lateral region.

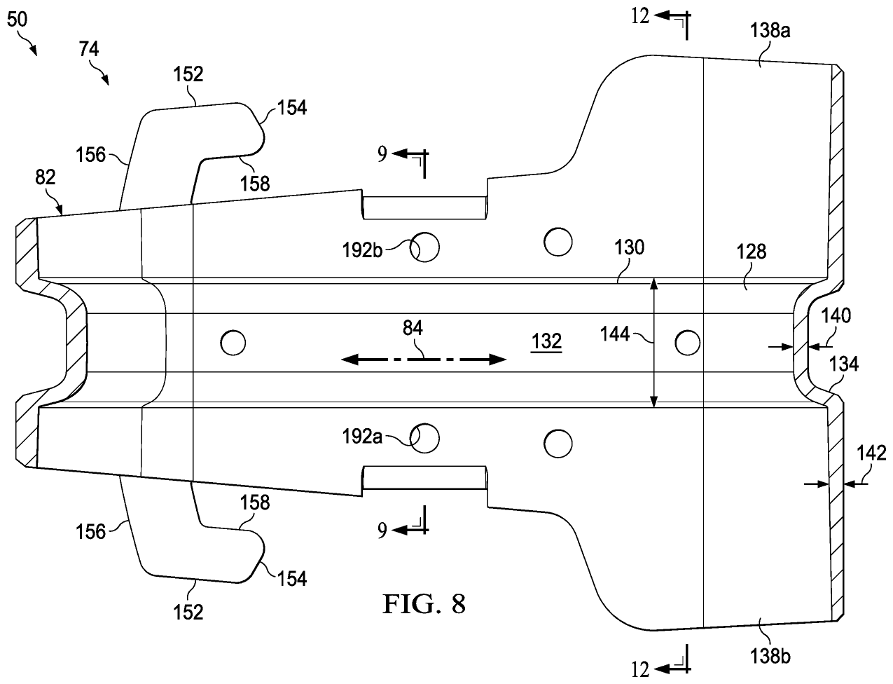

Encircling member 74 may have a rib 128 to provide load strength (see FIG. 8). Rib 128 may be included in encircling body 82 and thus may be formed integrally with other portions of encircling body 82. Rib 128 may extend along encircling path 84 in a plane. Rib 128 may form a ridge 130 defined by an inner surface 132 of encircling body 82 (and/or encircling member 74), and thus ridge 130 may be described as an inside ridge that projects into central opening 78. The rib may be a recessed rib, as depicted, that forms a groove 134 defined by an outer surface 136 of encircling body 82 (and/or encircling member 74) (also see FIG. 10). Accordingly, groove 134 may be described as an outside groove. Rib 128 may extend along any suitable portion of encircling path 84, such as along lower section 86, upper section 88, and/or one or both end sections 90, 92 (see FIG. 7). The rib may extend along at least one-half of encircling path 84, or at least substantially all of encircling path 84. Rib 128 may be centered across encircling body 82 (and/or encircling member 74), as depicted.

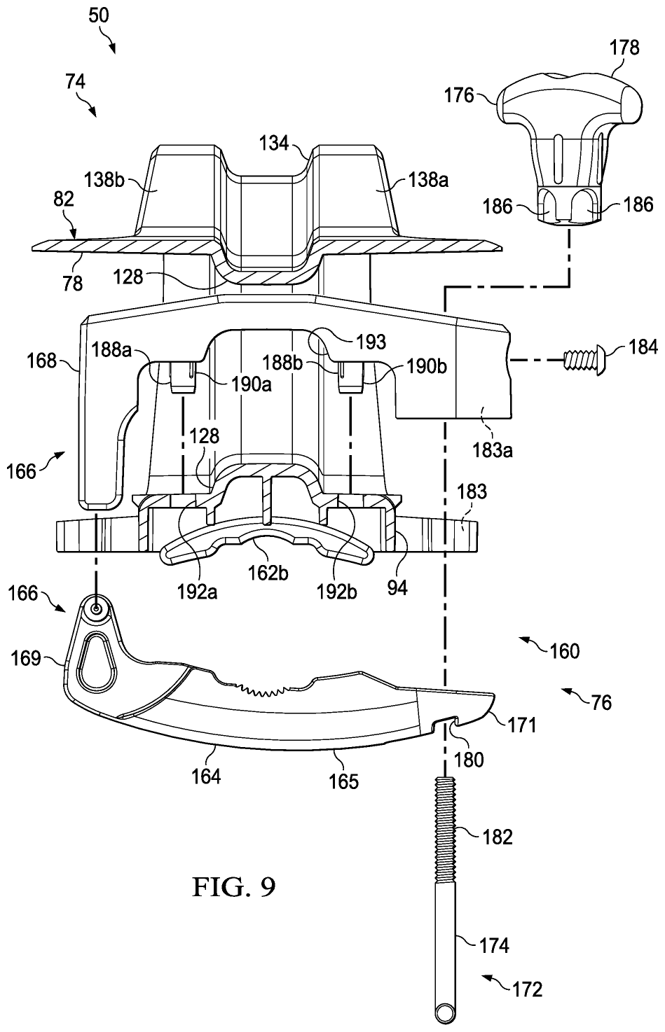

Rib 128 may be formed without substantially altering the thickness of encircling body 82 (and/or encircling member 74) (see FIGS. 8 and 9). A pair of flanking regions 138a, 138b may flank rib 128 along opposite sides thereof. Rib 128 may have a rib thickness 140 that is similar to a flanking thickness 142 of flanking regions 138a, 138b (see FIG. 8). Rib thickness 140 and flanking thickness 142 may differ from one another by less than a factor of two, or less than 50%, or may be substantially the same. A rib that does not substantially alter the thickness of encircling body 82, while increasing load strength, is advantageous because the rib does not substantially increase the weight or the amount of material of saddle mount 50.

Rib 128 may have any suitable dimensions (see FIG. 8). Groove 134 may be at least about as deep as, or deeper than, rib thickness 140, and my have a width that is greater than rib thickness 140, such as at least about 2, 3, 4, or 5 times the rib thickness. Ridge 130 may have a ridge width 144 that is at least about 10%, 20%, 25%, or 30% of a minimum or average width of encircling body 82 (and/or encircling member 74).

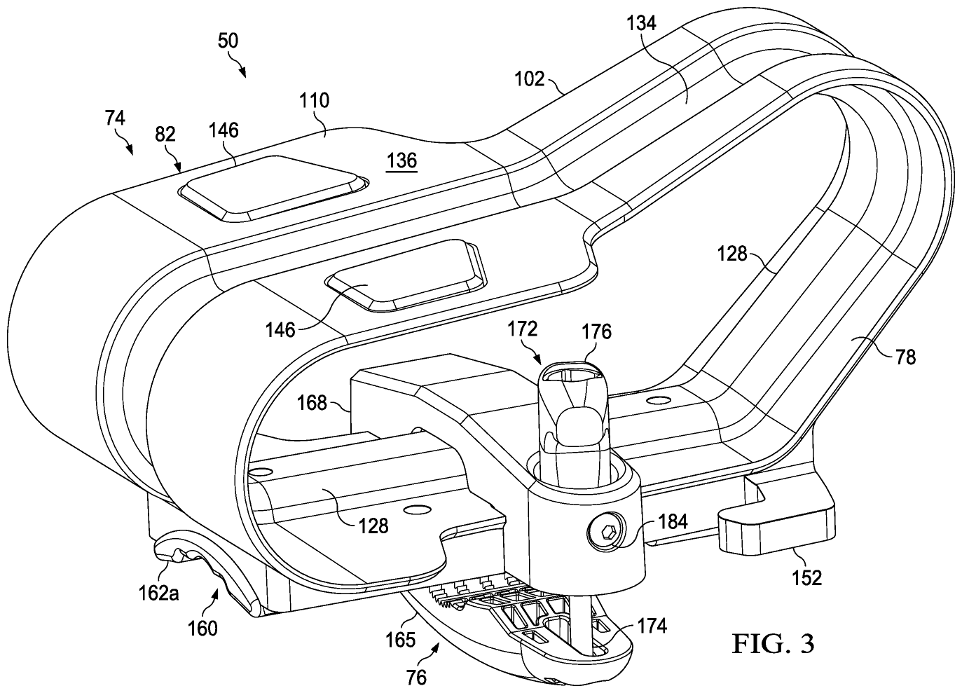

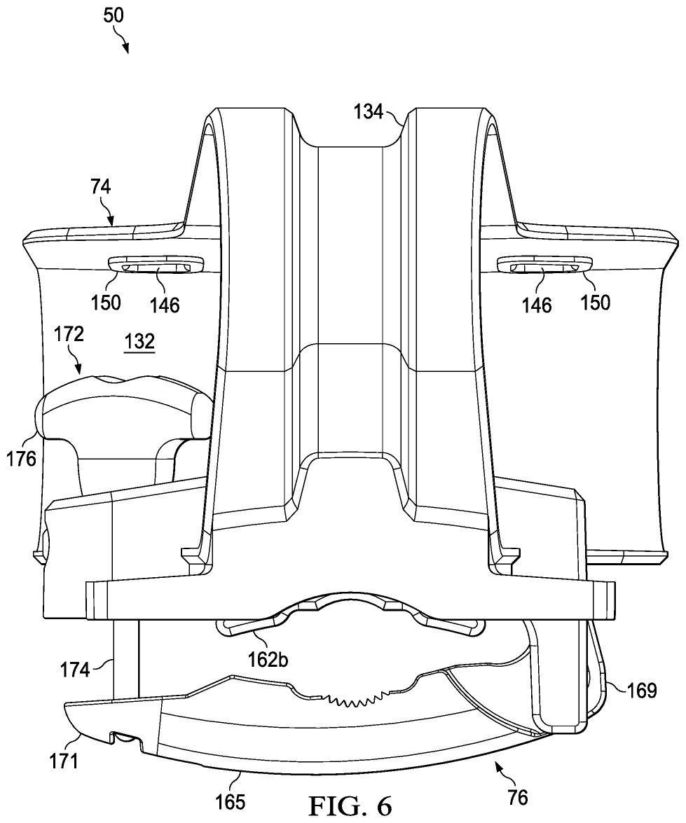

Encircling member 74, such as in medial portion 100, may be equipped with one or more frictional pads 146 to resist slippage of fishing kayak 56 on encircling member 74 (see FIGS. 3-7 and 10). Each frictional pad 146 protrudes above outer surface 136 of encircling body 82 for contact with fishing kayak 56. Frictional pad 146 has a higher coefficient of friction than outer surface 136 and may be formed of a softer polymer than encircling body 82. The pad may be received in an aperture 148 defined by encircling body 82 and may include a retaining flange 150 that keeps frictional pad 146 in the aperture (see FIGS. 6 and 10). Frictional pad 146 may be composed of an elastomer.

A pair of hooks 152 may be formed by encircling member 74. Hooks 152 may be configured to maintain proper alignment of a strap 62 for securing fishing kayak 56 onto saddle mounts 50, and/or to resist lateral slippage of strap 62 (see FIGS. 3 and 8; also see FIG. 1). Hooks 152 may project from opposite edges of encircling member 74 to respective distal ends 154. Each distal end 154 may be more medial that corresponding base 156 of the hook to create a recess 158 for strap retention. Hooks 152 may be formed integrally with, or separately from, encircling body 82.

Saddle mount 50 may include a clamp 160 to engage an appropriately shaped crossbar 54 (see FIGS. 3-6, 9, and 11). Clamp 160 may include one or more upper jaw members 162a, 162b, and a lower jaw member 164. The lower jaw member may be formed by a bail 165 of a bail assembly 166. Upper jaw members 162a, 162b provide fixed jaws configured to engage spaced positions along a top side of crossbar 54, and lower jaw member 164 provides a movable jaw configured to engage an underside of the crossbar. Upper jaw members 162a, 162b may formed integrally with, or separately from, encircling body 82. In the depicted example, upper jaw members 162a, 162b are separate pieces each having an interference fit with respective receiving areas defined by a bottom side of bottom section 94 at spaced positions along encircling path 84 (also see FIG. 7).

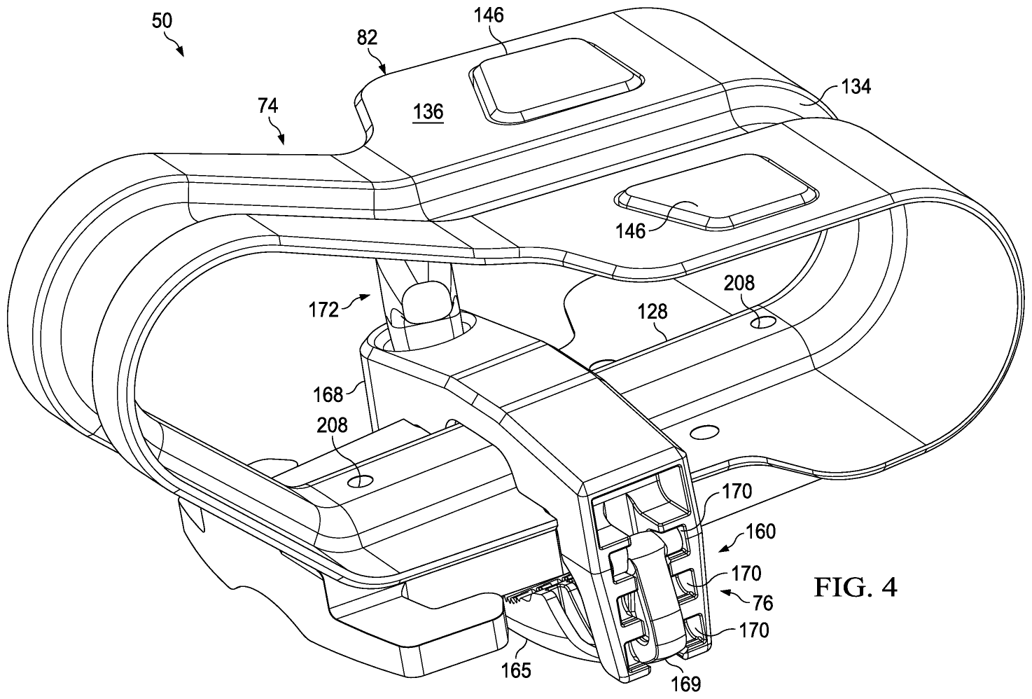

Bail 165 may be connected to encircling member 74 via a bail mount 168 of bail assembly 166 (see FIGS. 4, 5, and 9). A first end 169 of bail 165 may be pivotably coupled to bail mount 168 at one of two or more selectable positions created by slots 170, (see FIG. 4). A second end 171 of bail 165 may be connected to bail mount 168 via an actuator 172 (see FIG. 9). Suitable manipulation of actuator 172 urges second end 171 of bail 165 upward toward bail mount 168, which clamps crossbar 54 between the jaws of clamp 160.

Actuator 172 may include a fastener assembly having a bolt 174 and a nut member 176, which may include a graspable knob 178 (see FIG. 9). A head of bolt 174 may be retained by a slot 180 defined by second end 171 of bail 165. A threaded shaft 182 of bolt 174 may extend through an aperture 183 of encircling member 74 and an aperture 183a of bail mount 168 and into threaded engagement with nut member 176. Rotation of nut member 176 via graspable knob 178 in opposite rotational directions tightens or loosens clamp 160. A security screw 184 may be connected to bail mount 168. When crossbar 54 has been engaged with clamp 160, the leading end of security screw 184 may be advanced into one of a plurality of recesses 186 defined by nut member 176. The security screw in this advanced position prevents any rotation of nut member 176 to loosen clamp 160, including undesired rotation while transporting fishing kayak 56.

Bail mount 168 may be removably connected to encircling member 74. Bail mount 168 and encircling member 74 (e.g., encircling body 82 thereof) may fit together (e.g., along a vertical axis) such that movement of bail mount 168 with respect to encircling member 74 is prevented in a horizontal plane. For example, bail mount 168 may include one or more protrusions 188a, 188b, such as pins 190a, 190b, that fit into one or more corresponding holes 192a, 192b defined by encircling member 74, or the encircling member may include protrusions 188a, 188b and the bail mount may include holes 192a, 192b, or a combination thereof, or the like. The bail mount may define a recess 193 in a lower surface thereof, and recess 193 may be configured to receive a portion of rib 128. Accordingly, the lower surface of bail mount 168 may be shaped to match a top surface region of bottom section 94. Bail mount 168 fits together with encircling member 74 from central opening 78, such that at least a portion of bail mount 168 is located in the central opening and/or bail mount 168 extends through the central opening. Accordingly, bail mount 168 cannot be removed from encircling member 74 when both ends 169, 171 of bail 165 are coupled to bail mount 168 on opposite sides of encircling member 74.

Bail mount 168 may be reversible such that second end 171 of bail 165 and actuator 172 can be switchably positioned on either side of crossbar 54. In other words, bail mount 168 may be mated with encircling member 74 in each of two orientations that are offset from one another by 180 degrees. In one orientation, pins 190a, 190b are placed into respective holes 192a, 192b, and in the other orientation, the positions of pins 190a, 190b are switched by placing them into respective holes 192b, 192a. FIG. 2 shows saddle mounts 50 with bail mount 168 in each of the two orientations. The saddle mounts are arranged with encircling member 74 rotated 180 degrees with respect to one another about a vertical axis, but with actuators 172 on the same forward/aft side of crossbar 54, which is more convenient for the user.

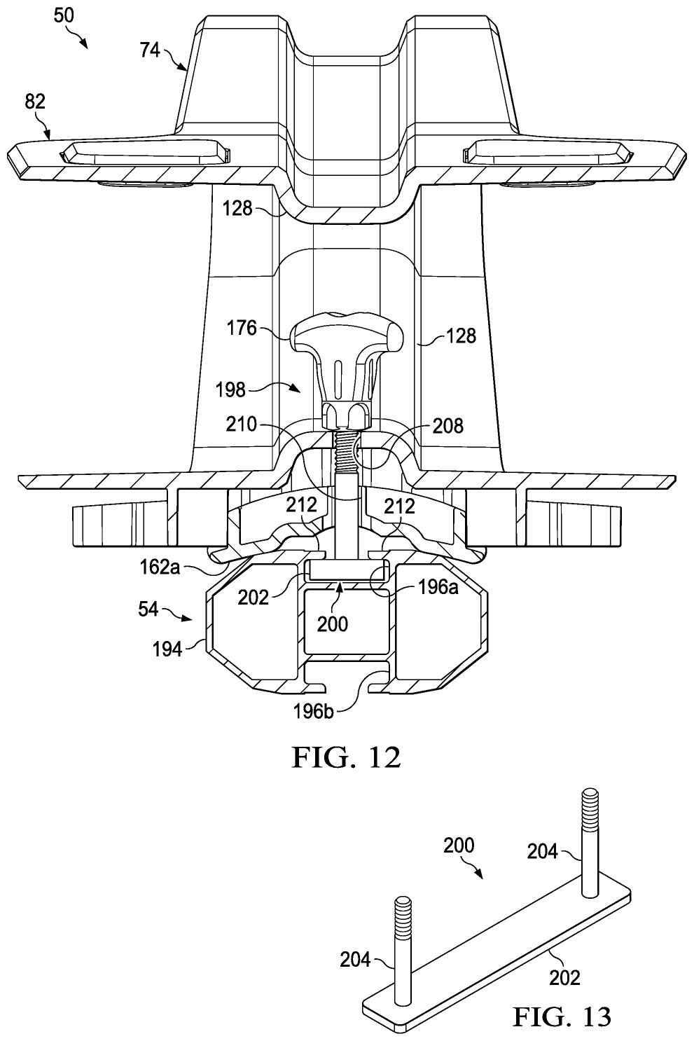

FIGS. 12-15 illustrate two other approaches to attaching saddle mount 50 to a crossbar 54. In each of these other approaches, bail assembly 166 (i.e., bail 165, bail mount 168, and actuator 172) has been replaced by a different crossbar-coupling assembly. However, in other examples, bail assembly 166 can be used together with either of these crossbar-coupling assemblies.

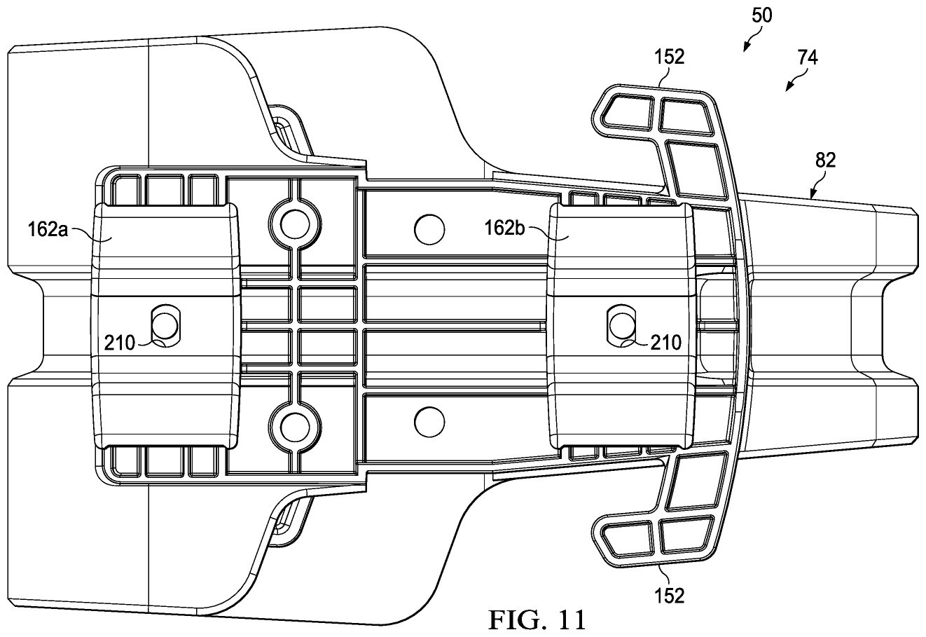

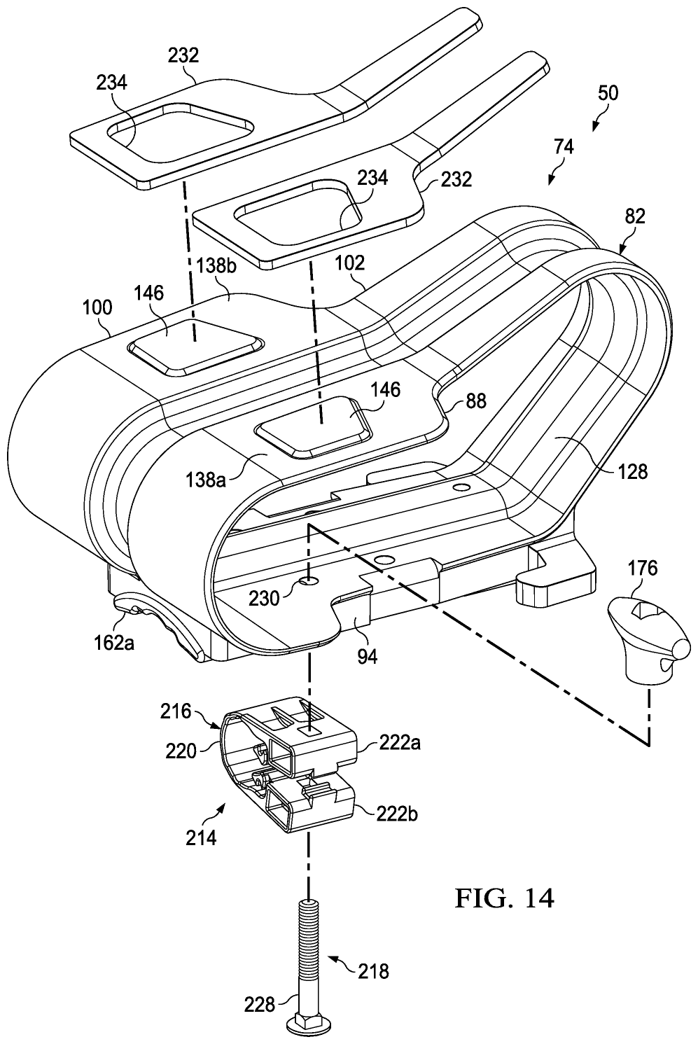

FIG. 12 shows saddle mount 50 attached to a crossbar 194 having upper and lower axial slots 196a, 196b structured as T slots. Lower axial slot 196b may be utilized to mount crossbar 194 to a pair of towers 197 of vehicle rack 52 (also see FIG. 1). Upper axial slot 196a may be utilized, as shown, to attach saddle mount 50 to crossbar 194 via a slot-coupling assembly 198 including a slidable member 200 and a pair of nut members 176 (also see FIG. 13). Slidable member 200 has a flat bar 202 configured to be slidably received in upper axial slot 196a from an end thereof. A pair of externally-threaded posts 204 project orthogonally from flat bar 202. Externally-threaded posts 204 are configured to be received from below encircling member 74 in a pair of through-holes. Each through-hole may include an upper aperture 208 defined by encircling body 82 and a lower aperture 210 defined by one of jaw members 162a, 162b (see FIGS. 11 and 12). Nut members 176 may be threaded onto threaded posts 204 and tightened against encircling body 82 (e.g., at rib 128). This tightening pulls flat bar 202 tightly against a pair of flanges 212 of upper axial slot 196a, and pulls an upper surface of crossbar 194 against upper jaw members 162a, 162b, to fix the position of encircling member 74 along crossbar 194.

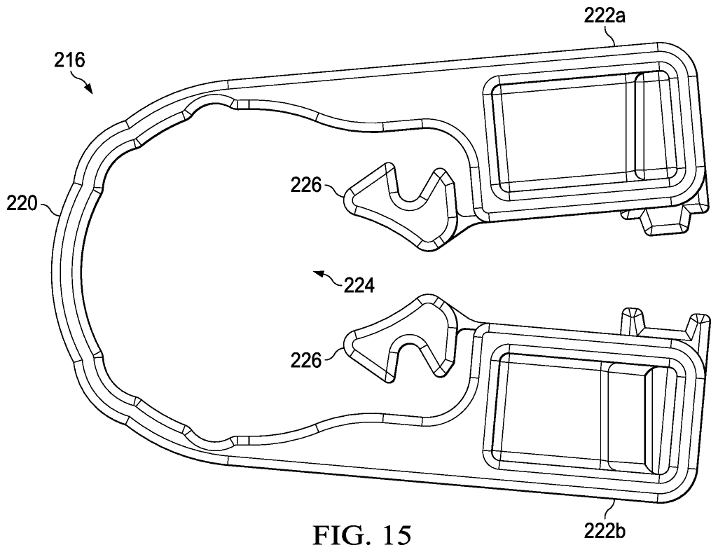

FIG. 14 shows a crossbar-clamping assembly 214 that may be utilized to attach saddle mount 50 to a crossbar 54 having a round cross-sectional shape. Crossbar-clamping assembly 214 may include a clamp member 216 to receive an axial portion of crossbar 54, and a fastener assembly 218 to attach clamp member 216 to encircling member 74. Clamp member 216 may be generally U-shaped, with a bridge region 220 connecting upper and lower mounting regions 222a, 222b to one another (also see FIG. 15). The clamp member defines a receiving space 224 for an axial portion of crossbar 54. Detachable members 226 extend into receiving space 224. The detachable members may be used to engage crossbar 54, when the crossbar is round, or may be detachably removed when crossbar 54 is rectangular. Fastener assembly 218 includes a bolt 228 to extend through clamp member 216 and a nut member 176 as described above (see FIG. 14). Bolt 228 extends through aligned apertures of mounting regions 222a, 222b, and through an aperture 230 of bottom section 94, and into threaded engagement with nut member 176. Clamp member 216 is configured to align crossbar 54 with upper jaw members 162a, 162b, such that the upper jaw members engage an upper surface region of crossbar 54 when clamp member 216 is tightened around the crossbar. This configuration, when used in conjunction with bail assembly 166 facilitates locking saddle mount 50 tightly onto crossbar 54 such that the saddle mount resists rotation about the round crossbar.

Saddle mount 50 may be equipped with one or more low-friction pads 232 to aid in slidable loading and unloading of fishing kayak 56 (see FIG. 14). Low-friction pads 232 may have an adhesive on a bottom surface thereof, to adhere each low-friction pad 232 to encircling body 82 of encircling member 74, such as only to the encircling bodies 82 of rear saddle mounts 50 (see FIG. 1). Each low-friction pad 232 may be formed of a material having a low coefficient of friction, such as felt. The low-friction pad 232 may define at least one hole 234 shaped to receive a protruding portion of at least one frictional pad 146. Low-friction pad 232 may be configured to be placed onto upper section 88 (e.g., onto medial and lateral portions 100, 102 of the upper section). Low-friction pad 232 may be restricted to one of flanking regions 138a, 138b, as shown here, or a single low-friction pad 232 may be utilized that spans rib 128 (if present).

### II. Selected Examples

This section describes selected examples of the present disclosure presented as a series of indexed paragraphs. These examples and those described above in Section I are intended for illustration only and should not limit or define the scope of the invention.

Paragraph A1. A saddle mount for supporting a fishing kayak above a crossbar attached to a vehicle, the saddle mount comprising: an encircling member configured to be attached to the crossbar, the encircling member having a horizontal bottom section and a top section, the top section including a medial portion and a lateral portion, the medial portion having an incline of less than about ten degrees and the lateral portion having an incline steeper than the incline of the medial portion.

Paragraph A2. The saddle mount of paragraph A1, wherein each incline has a constant slope.

Paragraph A3. The saddle mount of paragraph A1 or A2, wherein the medial portion is wider than the lateral portion.

Paragraph A4. The saddle mount of paragraph A3, wherein the medial portion is at least 50% wider than the lateral portion.

Paragraph A5. The saddle mount of any of paragraphs A1 to A4, wherein the medial portion is longer than the lateral portion.

Paragraph A6. The saddle mount of any of paragraphs A1 to A5, wherein the horizontal bottom section has a medial end and a lateral end, and wherein the medial end is wider than the lateral end.

Paragraph A7. The saddle mount of paragraph A6, wherein the medial end is at least 50% wider than the lateral end.

Paragraph A8. The saddle mount of any of paragraphs A1 to A7, wherein the encircling member follows an encircling path defining a plane, and wherein the encircling member is configured to be attached to the crossbar such that the plane is parallel to the crossbar.

Paragraph A9. The saddle mount of any of paragraphs A1 to A8, wherein the medial portion has one or more frictional pads to contact the hull of the fishing kayak.

Paragraph A10. The saddle mount of paragraph A9, wherein the encircling member includes an encircling body defining one or more apertures to receive the one or more frictional pads.

Paragraph A11. The saddle mount of paragraph A10, wherein each frictional pad of the one or more frictional pads includes a flange configured to retain the pad in an aperture of the one or more apertures.

Paragraph A12. The saddle mount of any of paragraphs A9 to A11, wherein the encircling body includes a rib, wherein the one or more frictional pads include a pair of frictional pads, and wherein the rib extends along the encircling body intermediate the pair of frictional pads.

Paragraph A13. The saddle mount of any of paragraphs A9 to A12, wherein each frictional pad is formed of an elastomer.

Paragraph A14. The saddle mount of any of paragraphs A1 to A13, wherein the encircling member has a rib for providing load strength.

Paragraph A15. The saddle mount of paragraph A14, wherein the rib is a recessed rib.

Paragraph A16. The saddle mount of any of paragraphs A1 to A15, wherein the saddle mount includes a crossbar-coupling assembly configured to attach the encircling member to the crossbar.

Paragraph A17. The saddle mount of any of paragraphs A1 to A16, further comprising any limitation or combination of limitations from paragraphs B1 to B10, C1 to C7, and D1 to D12.

Paragraph B1. A saddle mount for supporting a fishing kayak above a crossbar attached to a vehicle, the saddle mount comprising: an encircling member configured to be attached to the crossbar and including a rib for providing load strength, wherein the encircling member follows an encircling path, and wherein the rib is elongated along the encircling path.

Paragraph B2. The saddle mount of paragraph B1, wherein the rib is a recessed rib.

Paragraph B3. The saddle mount of paragraph B2, wherein the recessed rib is created by a groove defined by an outer surface of the encircling member and a corresponding ridge defined by an inner surface of the encircling member.

Paragraph B4. The saddle mount of paragraph B3, wherein the groove has a depth that is greater than a thickness of the recessed rib.

Paragraph B5. The saddle mount of any of paragraphs B2 to B4, wherein the rib is located intermediate a pair of flanking regions of the encircling member, and wherein a thickness of the pair of flanking regions and a thickness of the recessed rib differ by less than a factor of two, less than 50%, and/or are substantially the same.

Paragraph B6. The saddle mount of any of paragraphs B1 to B5, wherein the encircling member includes an encircling body, and wherein the rib is formed integrally with flanking regions of the encircling body adjacent the rib.

Paragraph B7. The saddle mount of any of paragraphs B1 to B6, wherein the rib is centered across the encircling member.

Paragraph B8. The saddle mount of any of paragraphs B1 to B7, wherein the rib extends along more than one-half of the encircling path.

Paragraph B9. The saddle mount of paragraph B8, wherein the rib completely encircles a central opening of the encircling member.

Paragraph B10. The saddle mount of any of paragraphs B1 to B9, wherein the encircling path defines a plane, and wherein the rib follows the encircling path in the plane.

Paragraph B11. The saddle mount of any of paragraphs B1 to B10, further comprising any limitation or combination of limitations from paragraphs A1 to A16, C1 to C7, and D1 to D12.

Paragraph C1. A saddle mount for supporting a fishing kayak above a crossbar attached to a vehicle, the saddle mount comprising: an encircling member following an encircling path defining a plane and configured to be attached to the crossbar such that the plane is parallel to the crossbar, the encircling member including a lower section, an upper section, and pair of end sections opposite one another, each end section extending along a curved portion of the encircling path from the lower section to the upper section.

Paragraph C2. The saddle mount of paragraph C1, wherein the lower section includes a horizontal bottom section and a sloped section, and wherein the sloped section extends from the horizontal bottom section to one of the end sections.

Paragraph C3. The saddle mount of paragraph C1 or C2, wherein each end section changes orientation by an angle of at least 120 degrees as the end section extends between the lower section and the upper section.

Paragraph C4. The saddle mount of any of paragraphs C1 to C3, wherein the pair of end sections are a medial end section and a lateral end section, and wherein the medial end section is wider than the lateral end section, optionally at least 50% wider than the lateral end section.

Paragraph C5. The saddle mount of any of paragraphs C1 to C4, wherein the upper section includes a medial portion and a lateral portion, and wherein the medial portion is longer than the lateral portion.

Paragraph C6. The saddle mount of paragraph C5, wherein the medial portion is at least 50% longer than the lateral portion.

Paragraph C7. The saddle mount of any of paragraphs C1 to C6, wherein the encircling member encircles and defines a single central opening.

Paragraph C8. The saddle mount of any of paragraphs C1 to C7, further comprising any limitation or combination of limitations from paragraphs A1 to A16, B1 to B10, and D1 to D12.

Paragraph D1. A saddle mount for supporting a fishing kayak above a crossbar attached to a vehicle, the saddle mount comprising: (a) an encircling member; and (b) a bail configured to engage an underside of the crossbar and connected to the encircling member via a bail mount, wherein the bail mount is removably connected to the encircling member.

Paragraph D2. The saddle mount of paragraph D1, wherein the bail mount is configured to be removably connected to the encircling member in either orientation of a pair of opposite orientations.

Paragraph D3. The saddle mount of paragraph D2, wherein the bail mount and the encircling member have corresponding features that fit together, while the encircling member is in each of the opposite orientations, to prevent motion of the bail mount relative to the encircling member in a plane.

Paragraph D4. The saddle mount of paragraph D2 or D3, wherein one of the bail mount and the encircling member has a first hole and a second hole, and wherein the other of the bail mount and the encircling member has a first protrusion and a second protrusion each configured to fit interchangeably into the first hole and the second hole.

Paragraph D5. The saddle mount of any of paragraphs D1 to D4, wherein an end of the bail is pivotably associated with the bail mount for rotation of the bail about a pivot axis.

Paragraph D6. The saddle mount of paragraph D5, further comprising an actuator extending between the bail mount and the bail at an opposite end of the bail.

Paragraph D7. The saddle mount of any of paragraphs D1 to D6, further comprising a crossbar-coupling assembly configured to attach the encircling member to a slot of a crossbar.

Paragraph D8. The saddle mount of any of paragraphs D1 to D7, further comprising a crossbar-coupling assembly configured to attach the encircling member to a round crossbar.

Paragraph D9. The saddle mount of paragraph D8, wherein the crossbar-coupling assembly includes a clamp member configured to be placed around an axial portion of a round crossbar.

Paragraph D10. The saddle mount of paragraph D9, wherein the crossbar-coupling assembly connects to the encircling member at a different position than the bail mount, such that the bail and the crossbar-coupling assembly are capable of adjustably engaging the crossbar at the same time.

Paragraph D11. The saddle mount of any of paragraphs D1 to D10, wherein at least a portion of the bail mount is located in a central opening encircled by the encircling member.

Paragraph D12. The saddle mount of any of paragraphs D1 to D11, wherein the bail mount is located at least partially inside the encircling member.

Paragraph D13. The saddle mount of any of paragraphs D1 to D12, further comprising any limitation or combination of limitations from paragraphs A1 to A16, B1 to B10, and C1 to C7.

Paragraph E1. An assembly including a pair of the saddle mounts mounted to the crossbar to create a saddle.

Paragraph F1. A method, comprising: supporting a fishing kayak or other boat on a plurality of the saddle mounts attached to a pair of crossbars of a vehicle rack.

### III. Conclusion

The disclosure set forth above may encompass multiple distinct inventions with independent utility. Although each of these inventions has been disclosed in its preferred form(s), the specific examples thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious. Inventions embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure. Moreover, ordinal indicators, such as first, second, or third, for identified elements are used to distinguish between the elements, and do not indicate a particular position or order of such elements, unless otherwise specifically stated. Finally, the present disclosure incorporates material by reference. If any ambiguity or conflict in the meaning of a term results from this incorporation by reference, the literal contents of this application govern construction of the term.

We claim:

1. A saddle mount for supporting a fishing kayak above a crossbar attached to a vehicle, the saddle mount comprising:
an encircling member configured to be attached to the crossbar, the encircling member having a horizontal bottom section and a top section, the top section including a medial portion and a lateral portion, the medial portion having an incline of less than about ten degrees and the lateral portion having an incline steeper than the incline of the medial portion.

2. The saddle mount of claim 1, wherein each incline has a constant slope.

3. The saddle mount of claim 1, wherein the medial portion is wider than the lateral portion.

4. The saddle mount of claim 1, wherein the medial portion is longer than the lateral portion.

5. The saddle mount of claim 1, wherein the encircling member follows an encircling path defining a plane and is configured to be attached to the crossbar such that the plane is parallel to the crossbar.

6. The saddle mount of claim 1, wherein the medial portion has one or more frictional pads to contact the hull of the fishing kayak.

7. The saddle mount of claim 1, wherein the encircling member has a rib for providing load strength.

8. The saddle mount of claim 1, wherein the saddle mount includes a crossbar-coupling assembly configured to attach the encircling member to the crossbar.

9. A saddle mount for supporting a fishing kayak above a crossbar attached to a vehicle, the saddle mount comprising:
an encircling member configured to be attached to the crossbar and including a rib for providing load strength, wherein the encircling member follows an encircling path, and wherein the rib is elongated along the encircling path.

10. The saddle mount of claim 9, wherein the rib is a recessed rib.

11. The saddle mount of claim 10, wherein the recessed rib is created by a groove defined by an outer surface of the encircling member and a corresponding ridge defined by an inner surface of the encircling member.

12. The saddle mount of claim 11, wherein the groove has a depth that is greater than a thickness of the recessed rib.

13. The saddle mount of claim 10, wherein the rib is located intermediate a pair of flanking regions of the encircling member, and wherein a thickness of the pair of flanking regions and a thickness of the recessed rib differ by less than a factor of two.

14. The saddle mount of claim 9, wherein the rib extends along more than one-half of the encircling path.

15. A saddle mount for supporting a fishing kayak above a crossbar attached to a vehicle, the saddle mount comprising:
an encircling member following an encircling path defining a plane and configured to be attached to the crossbar such that the plane is parallel to the crossbar, the encircling member including a lower section, an upper section, and pair of end sections opposite one another, each end section extending along a curved portion of the encircling path from the lower section to the upper section.

16. The saddle mount of claim 15, wherein each end section changes orientation by an angle of at least 120 degrees as the end section extends between the lower section and the upper section.

17. The saddle mount of claim 15, wherein the pair of end sections are a medial end section and a lateral end section, and wherein the medial end section is wider than the lateral end section.

18. The saddle mount of claim 15, wherein the encircling member encircles and defines a single central opening.

19. The saddle mount of claim 15, further comprising a bail configured to engage an underside of the crossbar and connected to the encircling member via a bail mount, wherein the bail mount is removably connected to the encircling member.

20. The saddle mount of claim 19, wherein the bail mount is configured to be removably connected to the encircling member in either orientation of a pair of opposite orientations.
